(19) United States
(12) Patent Application Publication
(10) Pub. No.: US 2009/0300903 A1
(43) Pub. Date: Dec. 10, 2009

(54) MOUNTING APPARATUS FOR HEAT SINK

(75) Inventor: GUANG YANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO.,LTD, Shenzhen City (CN); HON HAI PRECISION INDUSTRY CO., LTD., Tu-Cheng (TW)

(21) Appl. No.: 12/406,044

(22) Filed: Mar. 17, 2009

(30) Foreign Application Priority Data
Jun. 4, 2008 (CN) 200810301957.4

(51) Int. Cl. B23P 15/26

(52) U.S. Cl. 29/726

(57) ABSTRACT

A mounting apparatus is used for mounting a heat sink on a main board. The mounting apparatus includes a base, a load-supporting unit mounted on the base, a rack mounted on the base, and a pressing means movably mounted on the rack. The load-supporting unit includes a supporting means for supporting the main board, a first positioning means for positioning the main board, and a second positioning means for positioning the heat sink. The pressing means is used for pressing the heat sink.

### BACKGROUND

1. Technical Field

The disclosure relates to a mounting apparatus and, particularly, relates to a mounting apparatus used in a computer assembly line.

2. General Background

A heat sink is usually mounted on the central processing unit (CPU) of a computer in order to dissipate heat from the CPU. A heat conductive silicone grease layer is coated on the bottom surface of the heat sink to fill any voids between the heat sink and the CPU, transferring heat produced by the CPU more efficiently.

In assembling the heat sink to the CPU, the heat sink must be mounted along a direction perpendicularly to the upper surface of the CPU. The heat sink must then be properly aligned with the CPU and the heat conductive silicone grease be disposed evenly between the heat sink and the CPU. However, manually aligning the heat sink and disposing the grease are tedious and subjected to human errors, therefore, a mounting apparatus for the heat sink is needed for accuracy.

### BRIEF DESCRIPTION OF THE DRAWINGS

The elements in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic, isometric view of a mounting apparatus for a heat sink according to an exemplary embodiment.

FIG. 2 is similar to FIG. 1, but viewed from another angle.

FIG. 3 is an exploded view of the mounting apparatus of FIG. 1.

FIGS. 4-7 are schematic, isometric views, showing a process of mounting a heat sink on a main board of a computer by using the mounting apparatus of FIG. 1.

### DETAILED DESCRIPTION OF THE EMBODIMENTS

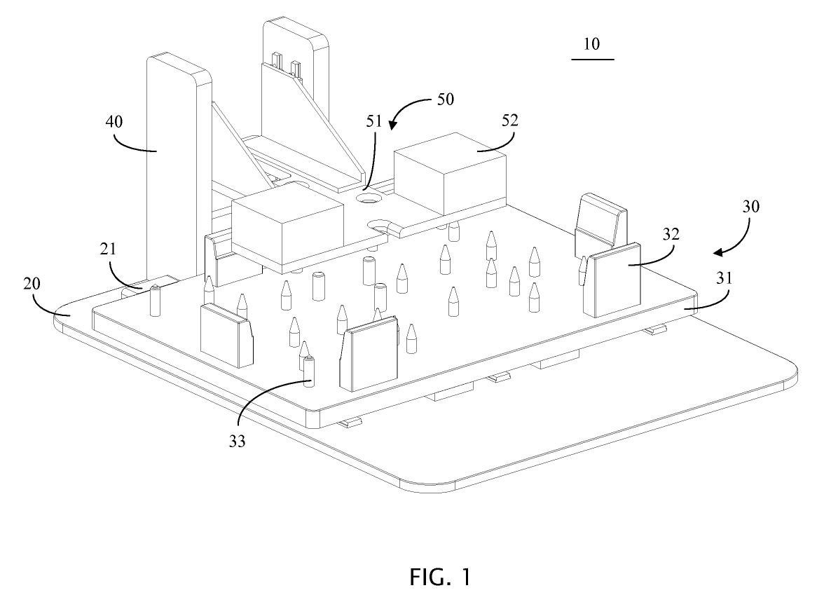

Referring to FIG. 1, a mounting apparatus 10 is disclosed. The mounting apparatus 10 includes a base 20, a load-supporting unit 30, a rack 40 mounted on the base 20, and a pressing means 50 mounted on the rack 40.

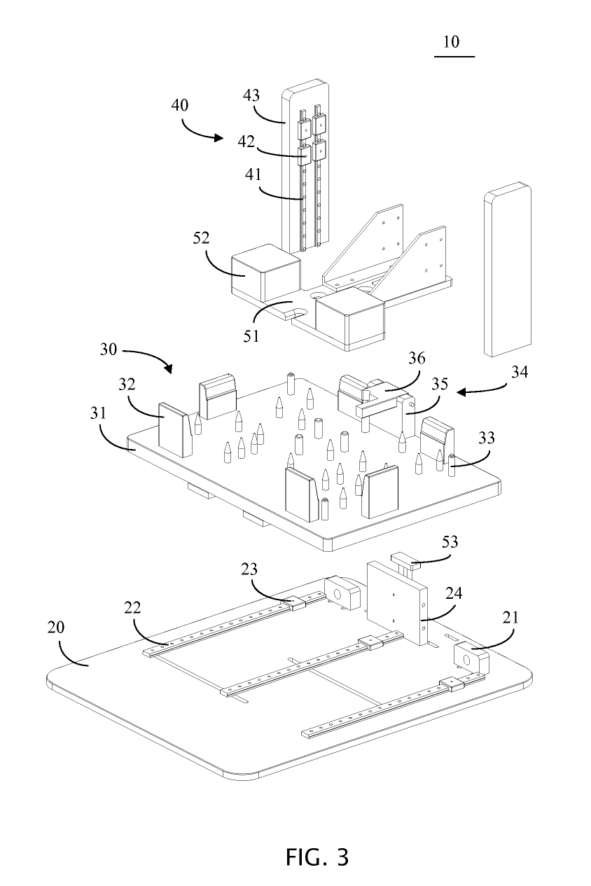

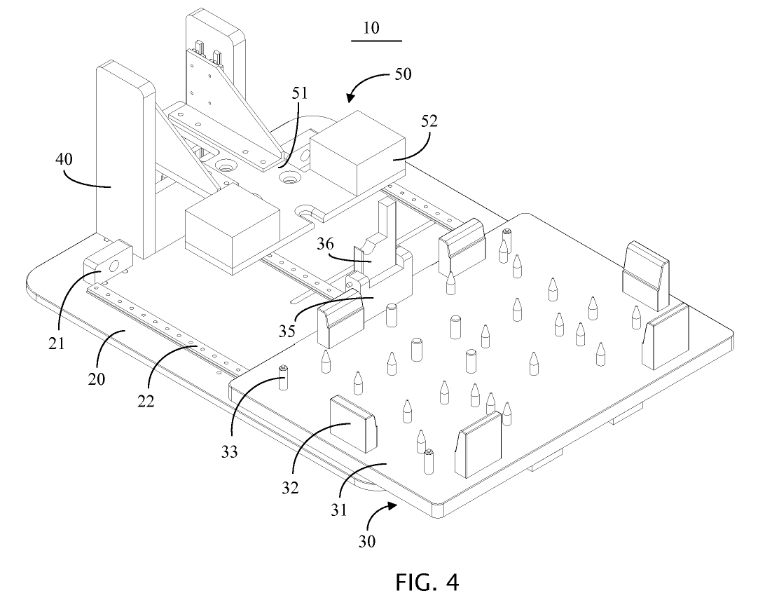

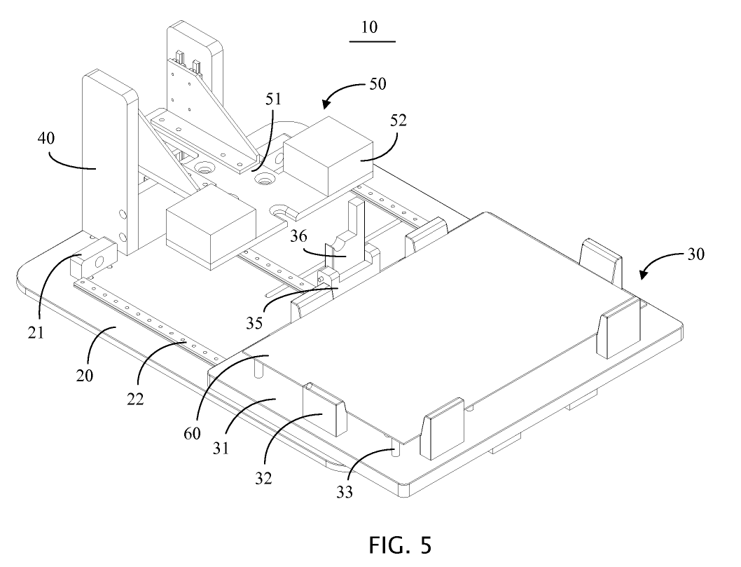

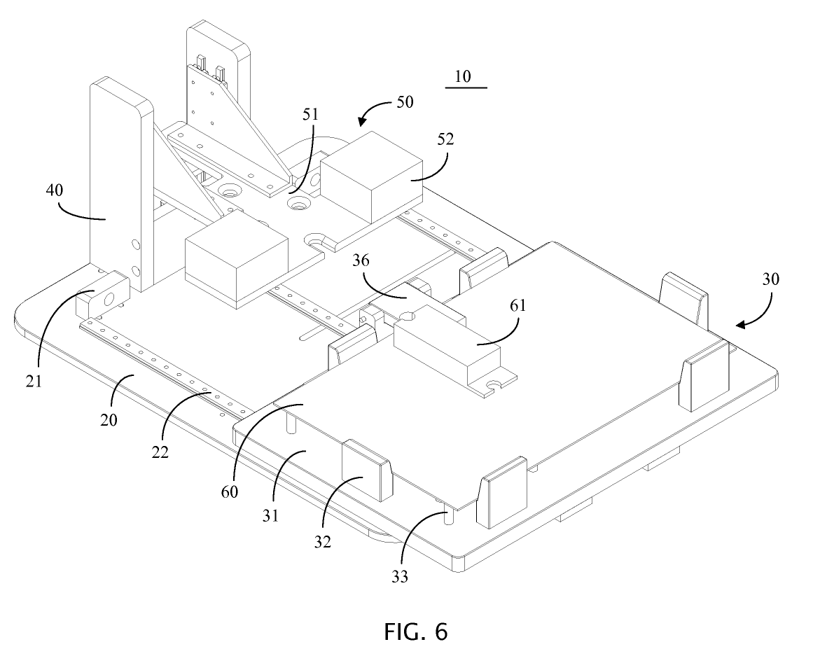

Referring to FIGS. 3 and 4, the load-supporting unit 30 includes a plate 31, a plurality of supporting means 33 for supporting a main board 60 (shown in FIG. 5), a first positioning means 32 for positioning the main board 60, and a second positioning means 34 for positioning a heat sink 61 (shown in FIG. 6). The heat sink 61 is positioned on a CPU mounted on the main board 60, but the CPU is not shown here for clarity.

In this embodiment, the supporting means 33 are rods. Some of the rods are flat on top and are configured for supporting a bottom surface of the main board 60, and the other rods are tapered and are configured for cooperating with corresponding holes defined in the main board 60. The first positioning means 32 are blocks and are positioned along edges of the plate 31. The second positioning means 34 includes a block 35 mounted on the plate 31 and a generally L-shaped portion 36 mounted on the block 35. The L-shaped portion 36 is rotatable toward or away from the plate 31.

The load-supporting unit 30 is movably mounted on the base 20 via sliding blocks 23 and rails 22. A locking means 21 for locking the load-supporting unit 30 is positioned on an end of the rails 22 adjacent to the rack 40. The load-supporting unit 30 is made of metal in this embodiment. The locking means 21 is magnetic, thus to attract and fix the load-supporting unit 30.

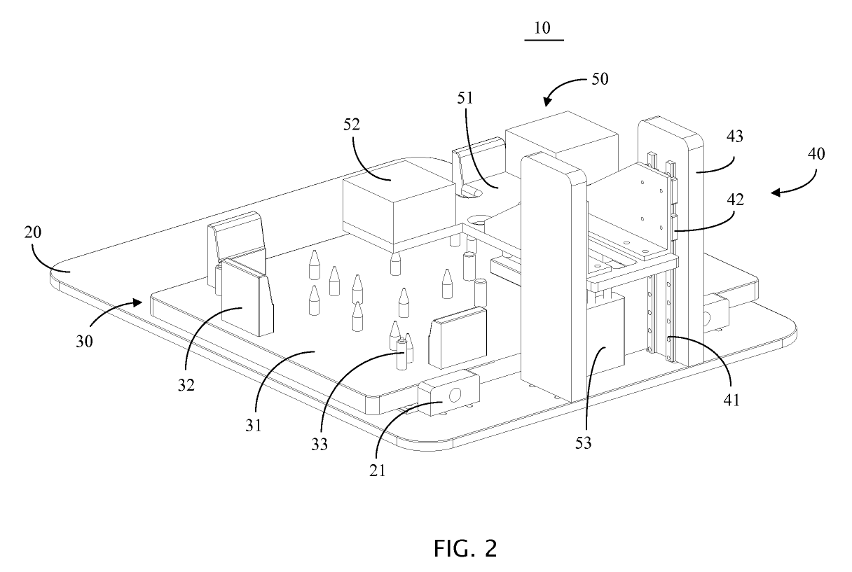

Referring to FIGS. 2 and 3, the rack 40 includes two sidewalls 43 facing each other. The pressing means 50 is movably mounted on the rack 40 via sliding blocks 42 and rails 41. The pressing means 50 includes a pressing board 51 and two weights 52 detachably attached on the pressing board 51.

The pressing means 50 further includes a motor 53. The motor 53 is mounted on a back wall 24 extending from the base 20 and is connected to the pressing board 51, and configured to drive the pressing board 51 to move up and down.

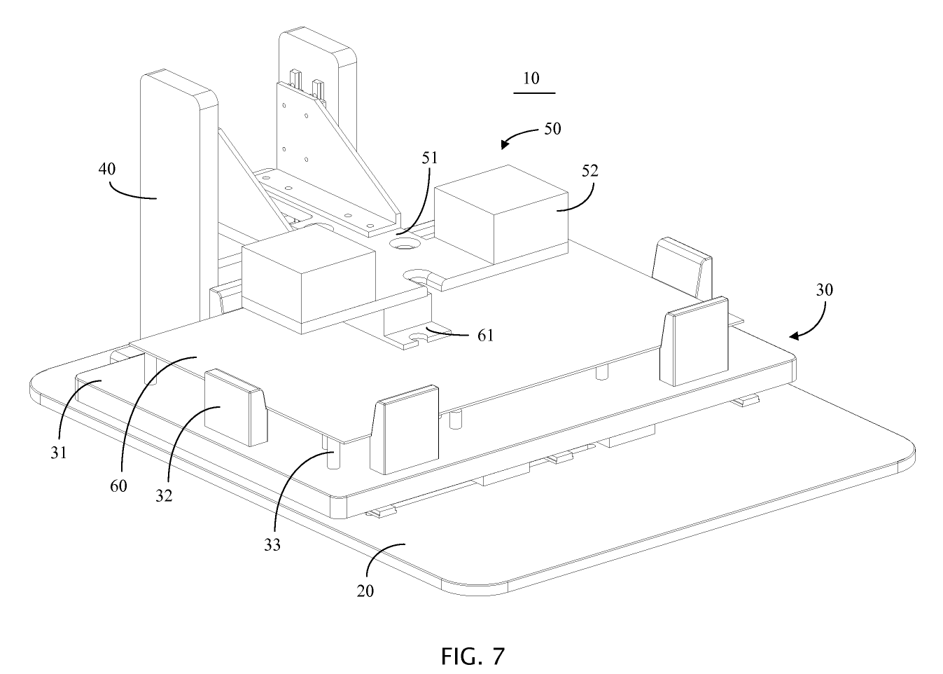

When mounting the heat sink 61 on the main board 60, first, referring to FIG. 4, the load-supporting unit 30 is positioned at an end of the rails 22 away from the locking means 21, the L-shaped portion 36 of the second positioning means 34 is positioned away from the plate 31, the pressing board 51 of the pressing means 50 is positioned at an upper end of the rails 41. Second, referring to FIG. 5, the main board 60 is placed on the supporting means 33 and is limited by the first positioning means 32. Third, referring to FIG. 6, the L-shaped portion 36 of the second positioning means 34 is rotated to a position near the plate 31, the heat sink 61 with heat conductive silicone grease coated on the bottom surface thereof is placed on the main board 60 and is positioned by the L-shaped portion 36. Fourth, referring to FIG. 7, the load-supporting unit 30 is moved to the other end of the rails 22 and is attracted to and held by the locking means 21. The motor 53 drives the pressing board 51 to move down and press the heat sink 61, causing the heat conductive silicone grease to be evenly disposed between the heat sink 61 and the CPU.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A mounting apparatus adapted for mounting a heat sink on a main board, the mounting apparatus comprising:
a base;
a load-supporting unit mounted on the base, comprising a supporting means for supporting the main board, a first positioning means for positioning the main board, and a second positioning means for positioning the heat sink;
a rack mounted on the base; and
a pressing means movably mounted on the rack, for pressing the heat sink.

2. The mounting apparatus of claim 1, wherein the load-supporting unit further comprises a plate, and wherein the supporting means, the first positioning means, and the second positioning means are mounted on the plate.

3. The mounting apparatus of claim 2, wherein the plate is slidably mounted on the base.

4. The mounting apparatus of claim 3, further comprising a locking means for locking the load-supporting unit.

5. The mounting apparatus of claim 4, wherein the load-supporting unit is made of metal, and the locking means is magnetic to attract and lock the load-supporting unit.

6. The mounting apparatus of claim 1, wherein the supporting means are rods.

7. The mounting apparatus of claim 2, wherein the first positioning means are blocks.

8. The mounting apparatus of claim 2, wherein the second positioning means comprises a block mounted on the plate and an L-shaped portion mounted on the block, and the L-shaped portion is rotatable toward or away from the plate.

9. The mounting apparatus of claim 1, wherein the pressing means comprises a pressing board.

10. The mounting apparatus of claim 9, wherein the pressing means further comprises a motor for driving the pressing board to move.
